(19) United States
(12) Patent Application Publication
(10) Pub. No.: US 2009/0231758 A1
(43) Pub. Date: Sep. 17, 2009

(54) HEAD SUSPENSION UNIT AND HEAD SUSPENSION ASSEMBLY

(75) Inventor: Takeshi Ohwe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/270,510

(22) Filed: Nov. 13, 2008

(30) Foreign Application Priority Data
Mar. 17, 2008 (JP) 2008-068540

(51) Int. Cl. G11B 5/60; G11B 5/48

(52) U.S. Cl. 360/234.3; 360/244.2; G9B/5.147; G9B/5.229

(57) ABSTRACT

A groove is formed on the surface of a base plate in a head suspension unit. A flexure extends from a load beam and received in the groove of the base plate. The flexure is thus allowed to extend outward from the contour of the base plate at a position closest to the rear end of the base plate. The area of the flexure is significantly reduced outside the contour of the base plate as compared with the case where the flexure extends outward from the contour of the base plate at a position closer to the front end of the base plate. Vibration of the flexure is suppressed. Even when a jig is urged against the base plate, the flexure is reliably prevented from being damaged. Simultaneously, a sufficiently large contact area is ensured between the base plate and the jig.

### BACKGROUND OF THE INVENTION

1. Field of the Invention

The present invention relates to a head suspension assembly incorporated in a storage apparatus such as a hard disk drive, HDD, for example.

2. Description of the Prior Art

A head suspension is well known as disclosed in Japanese Patent Application Publication No. 2004-95076, for example. The head suspension includes a base plate attached to the front or tip end of a carriage arm. Swaging technique is employed to attach the base plate. A load beam is coupled to the base plate. A hinge plate is utilized to couple the load beam. A flexure is attached to the surface of the load beam. A head slider is mounted on the flexure within a region received on the load beam.

The flexure includes a stainless steel plate. Wiring patterns are formed on the stainless steel plate. The flexure extends from the trailing end of the head slider to the rear end of the load beam. The flexure further extends outward from the contour of the load beam to the supported end of a carriage along the side of the carriage arm. The flexure is received in a groove formed in the side of the carriage arm. Electric connection is in this manner established between the head slider and a head IC (integrated circuit) on the supported end of the carriage through the wiring patterns on the stainless steel plate.

A cylindrical boss of the base plate is received in a through hole, defining a columnar hollow space, formed in the carriage arm for the attachment of the head suspension to the base plate. The base plate and the carriage arm are firmly held between predetermined jigs. A relatively large urging force is applied to the base plate against the carriage arm. A ball is then pushed into the cylindrical boss. The ball has the diameter larger than the inner diameter of the cylindrical boss, so that the cylindrical boss is forced to plastically deform to closely contact the inner wall surface of the through hole. In this manner, the head suspension is coupled to the carriage arm.

The base plate is urged against the carriage arm with a relatively large urging force for the alignment with a higher accuracy when the head suspension is attached to the carriage arm. It is thus required to maximize the contact area between the jig and the base plate. On the other hand, it is preferable to reduce the area of the flexure outside the contour of the load beam for reduction in vibration of the flexure. Vibration of the flexure results in deterioration of accuracy in positioning the head slider. Accordingly, the flexure preferably extends outward from the contour of the base plate at the position as close as possible to the rear end of the base plate.

However, the flexure has to extend outward from the contour of the load beam at a position forward from the front end of the base plate so as to ensure a sufficiently large contact area between the jig and the base plate. Vibration of the flexure is inevitable outside the contour of the load beam. On the other hand, in the case where the flexure extends outward from the contour of the base plate at a position closer to the rear end of the base plate, it is impossible to ensure a sufficiently large contact area between the jig and the base plate. Trade-off should be considered between suppression of vibration of the flexure and the establishment of a larger contact area between the jig and the base plate.

### SUMMARY OF THE INVENTION

It is accordingly an object of the present invention to provide a head suspension unit and a head suspension assembly contributing to establishment of a sufficiently large contact area between a jig and a base plate with a flexure enjoying suppression of vibration outside the contour of the base plate.

There is provided a head suspension unit comprising: a base plate; a load beam coupled to the front end of the base plate; a groove formed on the surface of the base plate; and a flexure extending from the load beam and received in the groove of the base plate, the flexure extending outward from the contour of the base plate.

The head suspension unit enables reception of the flexure in the groove over an area received on the base plate. The flexure is thus allowed to extend outward from the contour of the base plate at a position closest to the rear end of the base plate. The area of the flexure is significantly reduced outside the contour of the base plate as compared with the case where the flexure extends outward from the contour of the base plate at a position closer to the front end of the base plate. Vibration of the flexure is suppressed.

Moreover, the flexure is received in the groove in the course of attachment of the head suspension unit. The flexure is contained in a hollow space defined between the groove and an imaginary plane including the surface of the base plate. Even when a jig is urged against the base plate, the flexure is reliably prevented from being damaged. Simultaneously, a sufficiently large contact area is ensured between the base plate and the jig. A sufficient urging force can thus be applied to the base plate from the jig against the surface of the carriage arm. Misalignment or shift of position is prevented between the base plate, namely the head suspension unit, and the carriage arm.

The groove reaches the contour of the base plate at the rear end of the base plate in the head suspension unit. The flexure is thus allowed to extend outward from the contour of the base plate at the rear end of the base plate. The area of the flexure is further reduced outside the contour of the base plate, namely the carriage arm. Vibration of the flexure is further suppressed.

The groove extends symmetrically relative to the longitudinal centerline of the base plate. When the base plate is urged against the surface of the carriage arm, the urging force is uniformly applied to the entire surface of the base plate from a jig. Uneven warp or twist of the base plate is reliably prevented.

The base plate has a first surface and a second surface at the backside of the first surface in the head suspension unit. The base plate receives the load beam on the first surface. The groove is formed on the second surface No groove is formed on the first surface of the base plate in the head suspension unit. The jig is allowed to contact with the entire first surface of the base plate. A larger urging force is allowed to act on the base plate from the jig. Moreover, as compared with the case where the flexure is located on the surface of the base plate, the flexure is allowed to extend outward from the contour of the base plate at a position closer to the surface of the carriage arm. A difference in level is reduced between the groove formed in the side of the carriage arm and the flexure, for example. The flexure can thus be received in the groove of the carriage arm in a relatively facilitated manner. This results in improvement of efficiency in the assembling process of a carriage.

The head suspension unit may further comprise a hinge plate coupling the base plate to the load beam.

There is provided a head suspension assembly comprising: a base plate; a load beam coupled to the front end of the base plate; a groove formed on the surface of the base plate; a flexure extending from the load beam and received in the groove of the base plate, the flexure extending outward from the contour of the base plate; and a head slider mounted on the surface of the flexure on the load beam. The head suspension assembly is allowed to enjoy the advantages identical to those obtained in the aforementioned head suspension unit.

There is provided a carriage comprising: a carriage block supported on a support shaft for relative rotation; a carriage arm defined in the carriage block, the carriage arm extending forward; a base plate attached to the front end of the carriage arm; a load beam coupled to the front end of the base plate, the load beam extending forward from the front end of the base plate; a groove formed in the surface of the base plate; a flexure extending from the load beam and received in the groove of the base plate, the flexure extending outward from a contour of the base plate; and a head slider mounted on the surface of the flexure on the load beam. The carriage is allowed to enjoy the advantages identical to those obtained in the aforementioned head suspension unit. The carriage may be incorporated in a storage apparatus.

There is provided a head suspension unit comprising: a base plate; a load beam coupled to the front end of the base plate; a flexure body extending on the load beam and the base plate, the flexure body extending outward from the contour of the base plate; a groove formed on the surface of the flexure body on the base plate; and a wiring pattern formed on the surface of the flexure body, the wiring pattern received in the groove on the base plate.

The head suspension unit enables establishment of the groove on the surface of the flexure body in an area received on the base plate. The wiring pattern is received in the groove of the flexure body on the base plate. The wiring pattern is thus allowed to extend outward from the contour of the base plate at a position closer to the rear end of the base plate. As compared with the case where the wiring pattern extends outward from the contour of the base plate at a position closer to the front end of the base plate, the area of the wiring pattern, namely the area of the flexure body, is significantly reduced outside the contour of the base plate. Vibration of the flexure body is suppressed.

Moreover, the wiring pattern is received in the groove in the course of attachment of the head suspension unit. Even when a jig is urged against the surface of the flexure body on the base plate, the wiring pattern is reliably prevented from being damaged. Simultaneously, a sufficiently large contact area is ensured between the flexure body and the jig. A sufficient urging force can be applied to the flexure body and the base plate from the jig against the surface of the carriage arm. Misalignment of shift of position is prevented between the base plate, namely the head suspension unit, and the carriage arm.

There is provided a head suspension assembly comprising: a base plate; a load beam coupled to the front end of the base plate; a flexure body extending on the load beam and the base plate, the flexure body extending outward from the contour of the base plate; a groove formed on the surface of the flexure body on the base plate; a wiring pattern formed on the surface of the flexure body, the wiring pattern received in the groove on the base plate; and a head slider mounted on the surface of the flexure body on the load beam. The head suspension assembly is allowed to enjoy the advantages identical to those obtained in the aforementioned head suspension unit.

There is provided a head suspension unit comprising: a base plate; a load beam distanced forward from the front end of the base plate at a predetermined interval; a hinge plate attached to the base plate and the load beam; a groove formed on the surface of the hinge plate on the base plate; and a flexure extending on the load beam and the base plate and received in the groove of the hinge plate, the flexure extending outward from the contour of the base plate.

The head suspension unit enables establishment of the groove on the surface of the hinge plate in an area received on the base plate. The flexure is received in the groove of the hinge plate on the base plate. The flexure is thus allowed to extend outward from the contour of the base plate at a position closer to the rear end of the base plate. As compared with the case where a wiring pattern extends outward from the contour of the base plate at a position closer to the front end of the base plate, the area of the flexure is significantly reduced outside the contour of the base plate. Vibration of the flexure is suppressed.

Moreover, the flexure is received in the groove in the course of attachment of the head suspension unit. Even when a jig is urged against the surface of the hinge plate on the base plate, the flexure is reliably prevented from being damaged. Simultaneously, a sufficiently large contact area is ensured between the hinge plate and the jig. A sufficient urging force can be applied to the hinge plate and the base plate from the jig against the surface of the carriage arm. Misalignment of shift of position is prevented between the base plate, namely the head suspension unit, and the carriage arm.

There is provided a head suspension assembly comprising: a base plate; a load beam distanced forward from the front end of the base plate at a predetermined interval; a hinge plate attached to the base plate and the load beam; a groove formed on the surface of the hinge plate on the base plate; a flexure extending on the load beam and the base plate and received in the groove of the hinge plate, the flexure extending outward from the contour of the base plate; and a head slider mounted on the surface of the flexure on the load beam. The head suspension assembly is allowed to enjoy the advantages identical to those obtained in the aforementioned head suspension unit.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive, HDD, as a specific example of an electronic apparatus according to the present invention;

FIG. 2 is a plan view schematically illustrating a head suspension assembly according to a first embodiment of the present invention;

FIG. 3 is a partial sectional view schematically illustrating the head suspension assembly;

FIG. 4 is a sectional view taken along the line 4-4 in FIG. 2;

FIG. 5 is a sectional view schematically illustrating the process of attaching the head suspension assembly to a carriage arm;

FIG. 6 is a plan view schematically illustrating a head suspension assembly according to a second embodiment of the present invention;

FIG. 7 is a plan view schematically illustrating a head suspension assembly according to a third embodiment of the present invention;

FIG. 8 is a sectional view taken along the line 8-8 in FIG. 7;

FIG. 9 is a plan view schematically illustrating a head suspension assembly according to a fourth embodiment of the present invention;

FIG. 10 is a sectional view taken along the line 10-10 in FIG. 9;

FIG. 11 is a plan view schematically illustrating a head suspension assembly according to a fifth embodiment of the present invention;

FIG. 12 is a plan view schematically illustrating a head suspension assembly according to a sixth embodiment of the present invention; and

FIG. 13 is a sectional view taken along the line 13-13 in FIG. 12.

### DESCRIPTION OF THE PREFERRED EMBODIMENT

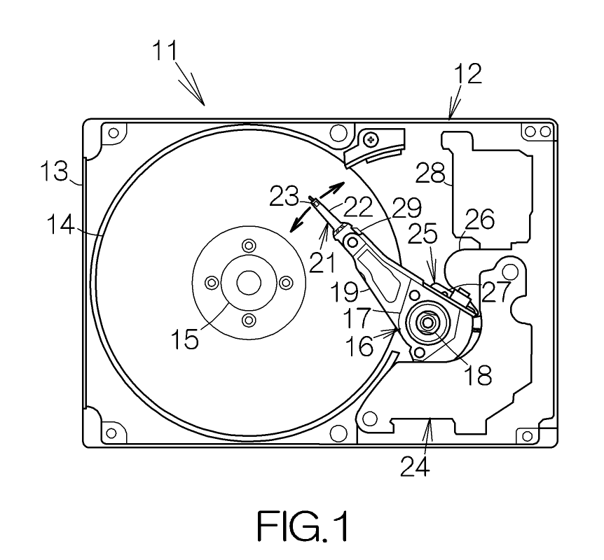

FIG. 1 schematically illustrates the structure of a hard disk drive, HDD, 11 as an example of a storage medium drive or a storage apparatus according to the present invention. The hard disk drive 11 includes an enclosure 12. The enclosure 12 includes a box-shaped base 13 and a cover, not shown. The base 13 defines an inner space in the form of a flat parallelepiped, for example. The base 13 may be made of a metallic material such as aluminum, for example. Molding process may be employed to form the base 13. The cover is coupled to the opening of the base 13. A closed space is defined between the base 13 and the cover. Pressing process may be employed to form the cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 extend in the horizontal direction from the vertical support shaft 18. The carriage block 17 may be made of aluminum, for example. Extrusion molding process may be employed to form the carriage block 17, for example.

A head suspension assembly 21 is attached to the front or tip end of the individual carriage arm 19. The head suspension assembly 21 includes a head suspension 22. The head suspension 22 extends forward from the tip end of the carriage arm 19. A flying head slider 23 is supported on the front or tip end of the head suspension 22. A head element or electromagnetic transducer is mounted on the flying head slider 23.

When the magnetic recording disk 14 rotates, the flying head slider 23 is allowed to receive airflow generated along the rotating magnetic recording disk 14. The airflow serves to generate a positive pressure or a lift as well as a negative pressure on the flying head slider 23. The lift is balanced with the negative pressure and the urging force from the head suspension 22 during the rotation of the magnetic recording disk 14. The flying head slider 23 is thus allowed to keep flying above the surface of the magnetic recording disk 14 at a higher stability.

When the carriage 16 swings around the vertical support shaft 18 during the flight of the flying head slider 23, the flying head slider 23 is allowed to move along the radial direction of the magnetic recording disk 14. The electromagnetic transducer on the flying head slider 23 is allowed to cross the data zone defined between the innermost recording track and the outermost recording track. The electromagnetic transducer on the flying head slider 23 can thus be positioned right above a target recording track on the magnetic recording disk 14.

A power source such as a voice coil motor, VCM, 24 is connected to the carriage block 17. The voice coil motor 24 serves to drive the carriage block 17 around the vertical support shaft 18. The rotation of the carriage block 17 allows the carriage arms 19 and the head suspensions 22 to swing.

As is apparent from FIG. 1, a flexible printed circuit board unit 25 is placed on the carriage block 17. The flexible printed circuit board unit 25 includes a head IC (integrated circuit) 27 mounted on a flexible printed wiring board 26. The head IC 27 is designed to supply the read element of the electromagnetic transducer with a sensing current when the magnetic bit data is to be read. The head IC 27 is also designed to supply the write element of the electromagnetic transducer with a writing current when the magnetic bit data is to be written.

A small-sized circuit board 28 is placed within the inner space of the enclosure 12. A printed wiring board, not shown, is attached to the backside of the bottom plate of the base 13. The head IC 27 receives the sensing current and the writing current from the small-sized circuit board 28 or the printed wiring board on the bottom plate through the small-sized circuit board 28. A flexure 29 is utilized to relay the sensing current and the writing current to the electromagnetic transducer. One end of the flexure 29 is connected to the flexible printed circuit board unit 25. The flexure 29 extends along the side of the carriage arm 19. The other end of the flexure 29 is attached to the head suspension 22.

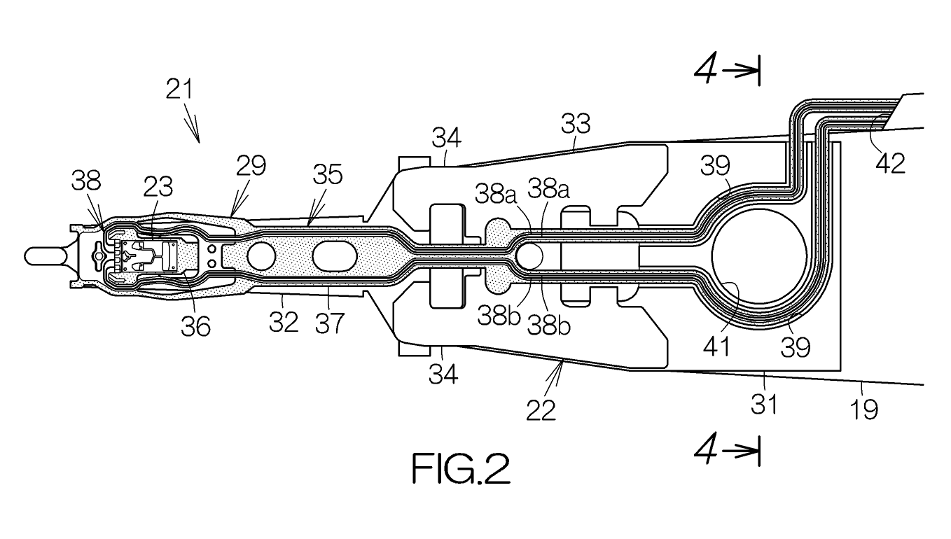

FIG. 2 schematically illustrates the head suspension assembly 21 according to a first embodiment of the present invention. The head suspension assembly 21 includes a base plate 31 and a load beam 32. The base plate 31 is attached to the tip end of the carriage arm 19. The load beam 32 is distanced forward from the base plate 31 at a predetermined interval. A hinge plate 33 is fixed to the surfaces of the base plate 31 and the load beam 32. The hinge plate 33 provides an elastic bending section 34 between the front end of the base plate 31 and the rear end of the load beam 32. The hinge plate 33 in this manner serves to couple the base plate 31 with the load beam 32. Each of the base plate 31, the load beam 32 and the hinge plate 33 is made out of a thin plate of stainless steel, for example.

The base plate 31, the load beam 32 and the hinge plate 33 in combination establish the head suspension 22. The aforementioned flexure 29 is attached to the front surface of the head suspension 22. The flexure 29 includes a flexure body, namely a stainless steel plate 35. The stainless steel plate 35 includes a support plate 36 and a fixation plate 37. The flying head slider 23 is received on the surface of the support plate 36. The fixation plate 37 is attached to the surfaces of the load beam 32 and the hinge plate 33. Spot welding may be effected at joint spots so as to fix the fixation plate 37, for example. The flying head slider 23 is bonded to the surface of the support plate 36. The support plate 36 and the fixation plate 37 are made out of a single thin plate of stainless steel.

A wiring pattern set 38 is formed on the surface of the fixation plate 37. One end of the wiring pattern set 38 is connected to the flying head slider 23. The wiring pattern set 38 includes a pair of wiring patterns 38a related to the read element and a pair of wiring patterns 38b related to the write element, for example. The fixation plate 37 is bifurcated on the hinge plate 33, for example. The bifurcated portions of the fixation plate 37 are respectively received in two grooves 39 formed on a first surface of the base plate 31, namely the front surface of the base plate 31. A through hole 41 penetrates through the base plate 31 from the front surface to the back surface of the base plate 31 at a position between the grooves 39. The grooves 39 are thus formed on the base plate 31 at both sides of the longitudinal centerline of the base plate 31, respectively. The individual groove 39 reaches the contour of the base plate 31 at the side of the base plate 31. The wiring patterns 38a and the wiring patterns 38b are formed in the bifurcated portions of the fixation plate 37, which are received in the grooves 39, respectively. One of etching process, stamping process and cutting process may be applied to the base plate 31 so as to form the grooves 39, for example.

The fixation plate 37 extends outward from the contour of the base plate 31 at the side of the base plate 31. The fixation plate 37 is bent at right angles at a position outside the contour of the base plate 31. The fixation plate 37 thus extends to the flexible printed circuit board unit 25 along the side of the carriage arm 19. The fixation plate 37 is received in a groove 42 formed in the side of the carriage arm 19. The head suspension assembly 21 in this manner has the structure of a so-called long tail. The other end of the wiring pattern set 38 is connected to the head IC 27. Electrical connection is thus established between the flying head slider 23 and the head IC 27. The base plate 31, the load beam 32, the hinge plate 33 and the flexure 29 in combination establish a head suspension unit according to the present invention.

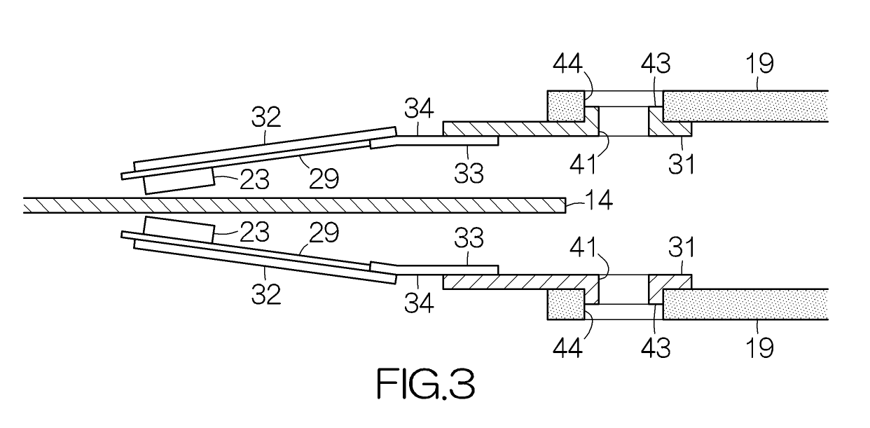

As shown in FIG. 3, a second surface of the base plate 31, namely the back surface of the base plate 31, is received on the front surface of the carriage arm 19. The base plate 31 includes a cylindrical boss 43 standing upright from the back surface of the base plate 31 around the aforementioned through hole 41. The cylindrical boss 43 serves to define the aforementioned through hole 41 inside. The cylindrical boss 43 is received in a through hole 44 defined in the tip end of the carriage arm 19. The through hole 44 penetrates through the carriage arm 19 from the front surface to the back surface of the carriage arm 19. The cylindrical boss 43 of the base plate 31 is urged against the inner wall surface of the through hole 44 based on swaging process. The swaging process will be described later in detail. The base plate 31 is in this manner fixed to the carriage arm 19.

The support plate 36 of the flexure 29 is received on a domed swelling, not shown, formed on the surface of the load beam 32 behind the flying head slider 23. The aforementioned elastic bending section 34 is designed to exhibit elasticity or bending force of a predetermined intensity. The bending force is utilized to provide the front end of the load beam 32 with the aforementioned urging force toward the surface of the magnetic recording disk 14. The domed swelling behind the flying head slider 23 serves to apply the urging force to the flying head slider 23. The flying head slider 23 is allowed to enjoy a change in its flying attitude based on the lift generated based on airflow. The domed swelling accepts a change in the attitude of the flying head slider 23, namely the support plate 36.

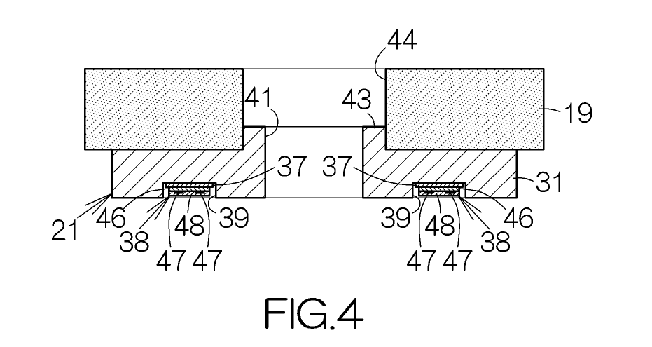

As shown in FIG. 4, the flexure 29, namely the wiring pattern set 38, is located in the grooves 39 on the base plate 31. The flexure 29 is contained in the hollow spaces defined between the grooves 39 and an imaginary plane including the front surface of the base plate 31, respectively. The fixation plate 37 of the flexure 29 is fixed to the bottom surfaces of the grooves 39. An adhesive may be utilized to fix the fixation plate 37. It should be noted that spot welding may alternatively be employed to fix the fixation plate 37 to the bottom surfaces of the grooves 39. The wiring pattern set 38 includes an insulating layer 46, an electrically-conductive layer 47 and a protection layer 48, overlaid on the fixation plate 37 in this sequence, for example. The electrically-conductive layer 47 is made of an electrically-conductive material such as copper, for example. The insulating layer 46 and the protection layer 48 are made of a resin material such as polyimide resin, for example.

The flexure 29 is received in the grooves 39 on the base plate 31 in the head suspension assembly 21. The flexure 29 is thus allowed to extend outward from the contour of the base plate 31 at a position closest to the rear end of the base plate 31. The area of the flexure 29 is significantly reduced outside the contour of the base plate 31 as compared with the case where a flexure extends outward from the contour of the hinge plate 33 at a position forward from the base plate 31, for example. Vibration of the flexure 29 is suppressed. The flying head slider 23 can be positioned with a higher accuracy. In addition, since the through hole 41 allows the wiring patterns 38a, 38b to be distanced from each other on the base plate 31, transmission of noise is prevented between the wiring patterns 38a, 38b.

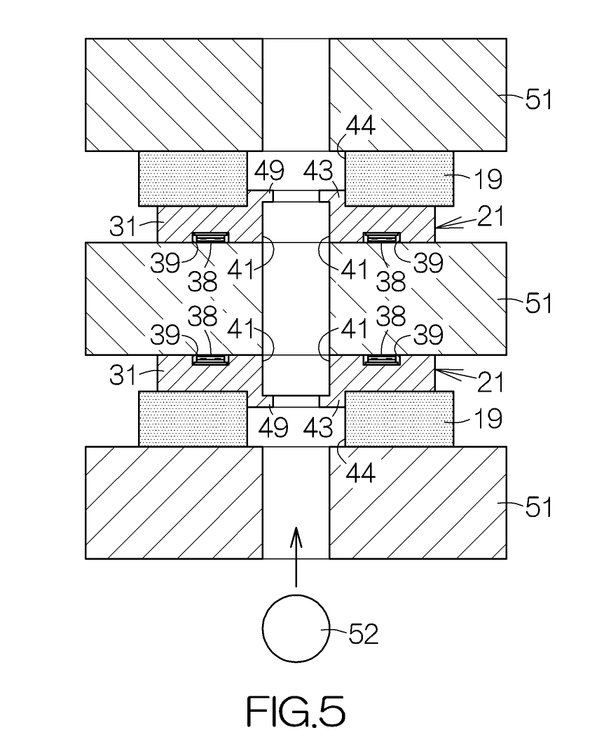

Next, description will be made on a method of making the carriage 16. The carriage block 17 is first prepared. The head suspension assembly 21 has already been assembled. The flexure 29 is located in the grooves 39 positioned on the base plate 31. As shown in FIG. 5, the cylindrical boss 43 of the base plate 31 is received in the through hole 44 of the carriage arm 19. A circular flange 49 is formed in the inner wall surface of the cylindrical boss 43. The flange 49 protrudes into the through hole 41. The base plate 31 and the carriage arm 19 are interposed between the flattened surfaces of jigs 51. The base plate 31 is in this manner urged against the front surface of the carriage arm 19. Since the flexure 29 is received in the grooves 39, the wiring pattern set 38 is prevented from suffering from damages resulting from the urging force applied from the jigs 51.

A ball 52 for swaging process is pushed into the through hole 41 of the base plate 31 while the jigs 51 are kept urged. The diameter of the ball 52 is set slightly larger than the inner diameter of the through hole 41. When the ball 52 is pushed into the through hole 41, the through hole 41 receives an outward force in the radial direction so that the through hole 41 expands. The flange 49 is squashed against the inner wall surface of the through hole 44 of the carriage arm 19. The flange 49 is thus forced to plastically deform. The plastic deformation of the flange 49 results in establishment of the cylindrical boss 43. The cylindrical boss 43 is firmly fixed in the through hole 44 of the carriage arm 19. The head suspension assembly 21 is fixed to the tip end of the carriage arm 19. In this manner, the carriage 16 is produced.

The method enables reception of the wiring pattern set 38 in the grooves 39. The wiring pattern set 38 is completely contained in the hollow spaces defined between the grooves 39 and the imaginary plane including the front surface of the base plate 31. Even when the flattened surface of the jig 51 is urged against the base plate 31, the wiring pattern 38 is reliably prevented from being damaged. Simultaneously, a sufficiently large contact area is ensured between the base plate 31 and the jig 51. A sufficient urging force is applied to the base plate 31 against the front surface of the carriage arm 19 from the jig 51. A misalignment or shift of position is prevented between the base plate 31, namely the head suspension assembly 21, and the carriage arm 19.

The grooves 39 are formed at both sides of the longitudinal centerline of the base plate 31, respectively. When the jig 51 is applied, the contact area is equalized on the base plate 31 as much as possible between both sides of the longitudinal centerline of the base plate 31 as compared with the case where the groove 39 is formed around the through hole 41 on one side of the longitudinal centerline of the base plate 31. The urging force applied from the jig 51 to the entire surface of the base plate 31 is thus balanced as much as possible between both sides of the longitudinal centerline around the through hole 41. Warp or twist of the base plate 31 is prevented. The head suspension assembly 21 can thus be attached to the carriage arm 19 as designed or expected.

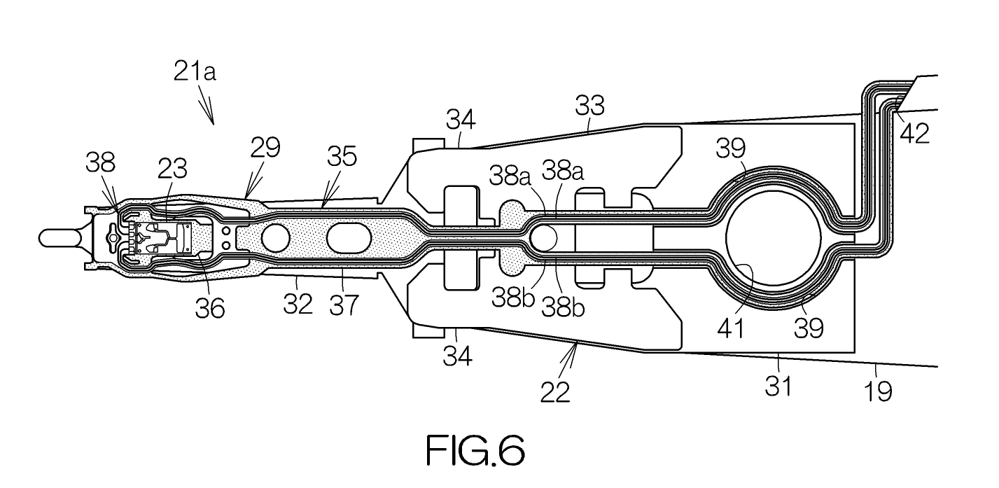

FIG. 6 schematically illustrates a head suspension assembly 21a according to a second embodiment of the present invention. The head suspension assembly 21a, includes the grooves 39 reaching the contour of the base plate 31 at the rear end of the base plate 31. The grooves 39 are thus allowed to extend on the base plate 31 symmetrically with each other relative to the longitudinal centerline of the base plate 31. The flexure 29 extends outward from the contour of the base plate 31 at the rear end of the base plate 31. Here, the flexure 29 may be attached to the front surface of the carriage arm 19 at a position backward from the rear end of the base plate 31. An adhesive may be utilized to attach the flexure 29, for example. Like reference numerals are attached to the structure or components equivalent to those of the aforementioned head suspension assembly 21.

The grooves 39 are formed on the base plate 31 symmetrically with each other relative to the longitudinal centerline of the base plate 31 in the head suspension assembly 21a. When the base plate 31 is urged against the front surface of the carriage arm 19, the urging force of the jig 51 uniformly acts on the entire surface of the base plate 31. Warp or twist of the base plate 31 is reliably prevented. Moreover, the flexure 29 extends outward from the contour of the base plate 31 at the rear end of the base plate 31. The area of the flexure 29 is further reduced outside the contour of the base plate 31, namely the carriage arm 19. Vibration of the flexure 29 is further suppressed.

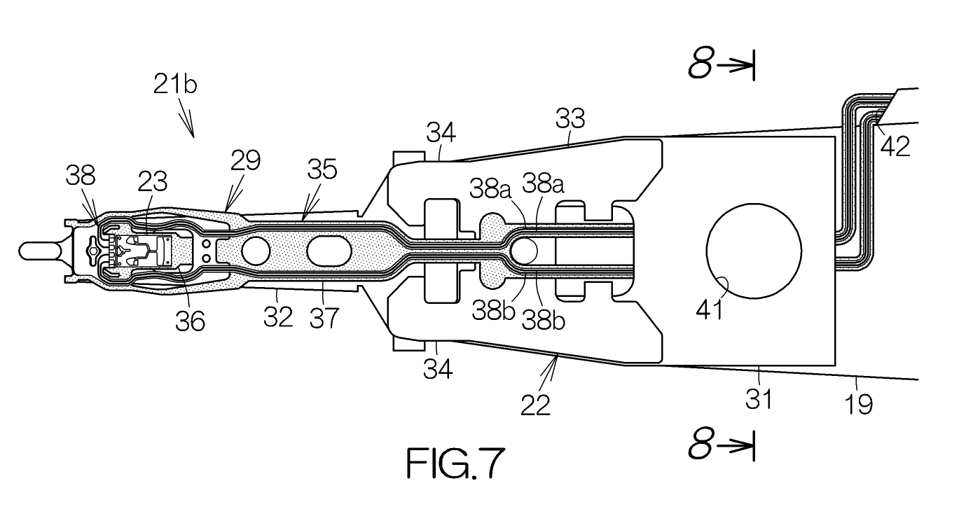

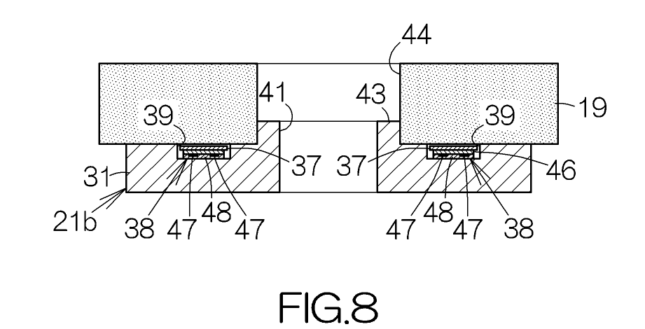

FIG. 7 schematically illustrates a head suspension assembly 21b according to a third embodiment of the present invention. The flexure 29 is located between the carriage arm 19 and the base plate 31 in the head suspension assembly 21b. As shown in FIG. 8, the grooves 39 are formed on the back surface of the base plate 31. The grooves 39 may extend in the same manner as described above. The flexure 29, namely the wiring pattern set 38, is received in the grooves 39. The flexure 29 may be attached to the bottom surfaces of the grooves 39. An adhesive is utilized to attach the flexure 29, for example. The grooves 39 may extend from the front end to the rear end of the base plate 31. Like reference numerals are attached to the structure or components equivalent to those of the aforementioned head suspension assemblies 21, 21a.

The grooves 39 are not formed in the front surface of the base plate 31. The front surface of the base plate 31 is thus allowed to entirely contact with the flattened surface of the jig 51. A larger urging force can be applied to the base plate 31 from the jig 51. Moreover, the flexure 29 extends outward from the contour of the side of the base plate 31 at a position closer to the front surface of the carriage arm 19 as compared with the case where the flexure 29 is located on the front surface of the base plate 31. A difference in level is reduced between the flexure 29 and the groove formed in the side of the carriage arm 19. The flexure 29 can thus be received in the groove of the carriage arm 19 in a relatively facilitated manner. This results in improvement of efficiency in the assembling process of the carriage 16. The head suspension assembly 21b is allowed to enjoy the advantages identical to those obtained in the aforementioned head suspension assemblies 21, 21a.

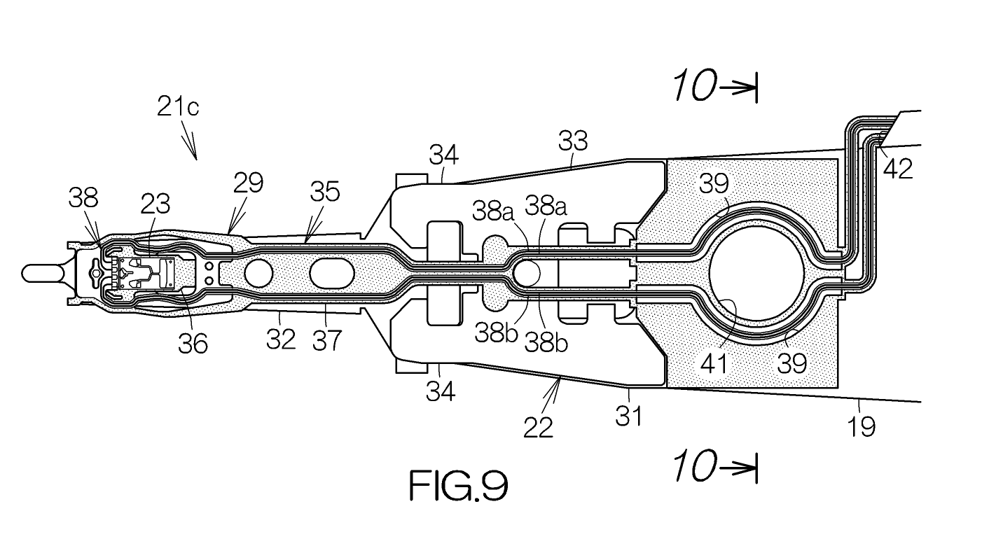

FIG. 9 schematically illustrates a head suspension assembly 21c according to a fourth embodiment of the present invention. The fixation plate 37 of the flexure 29 extends on the base plate 31. Spot welding is employed to fix the fixation plate 37 on the front surface of the base plate 31, for example. The aforementioned grooves 39 are formed not on the front surface of the base plate 31 but on the surface of the fixation plate 37 of the flexure 29 within an area received on the base plate 31. The grooves 39 may extend in the same manner as described above. The wiring pattern set 38 is located in the grooves 39. Etching may be effected on the fixation plate 37 so as to form the grooves 39, for example.

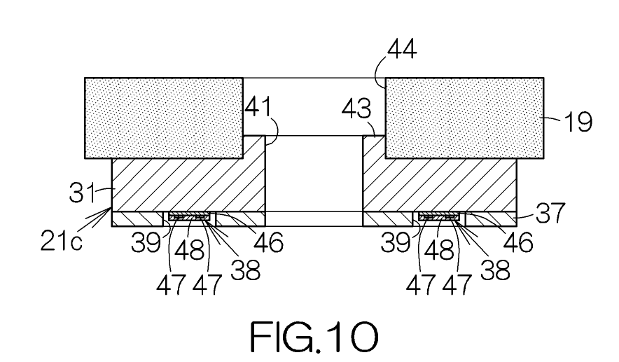

As shown in FIG. 10, the wiring pattern set 38 is contained in the hollow spaces defined between the grooves 39 and an imaginary plane including the surface of the flexure 29 on the base plate 31. The front surface of the base plate 31 is exposed within the grooves 39. The bottom surfaces of the grooves 39 are defined in the front surface of the base plate 31. The wiring pattern set 38 is attached to the front surface of the base plate 31 within the grooves 39. An adhesive is utilized to attach the wiring pattern set 38, for example. Like reference numerals are attached to the structure or components equivalent to those of the aforementioned head suspension assemblies 21, 21a, 21b. The head suspension assembly 21c is allowed to enjoy the advantages identical to those obtained in the aforementioned embodiments.

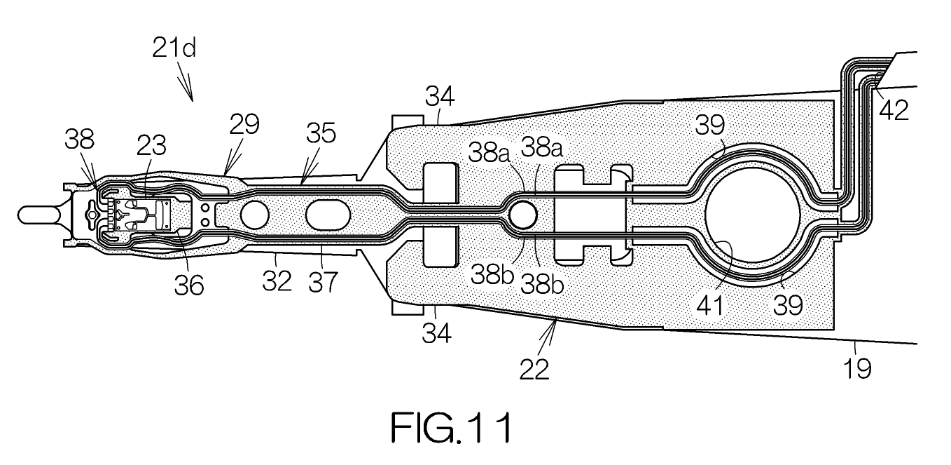

FIG. 11 schematically illustrates a head suspension assembly 21d according to a fifth embodiment of the present invention. The structure of the head suspension assembly 21d is identical to that of the head suspension assembly 21c except that the hinge plate 33 is replaced with the fixation plate 37 of the flexure 29. In other words, the elastic bending section 34 is formed in the fixation plate 37. The base plate 31 and the load beam 32 are coupled to each other through the fixation plate 37. Like reference numerals are attached to the structure or components equivalent to those of the aforementioned head suspension assemblies 21, 21a, 21b, 21c. The head suspension assembly 21d is allowed to enjoy the advantages identical to those obtained in the aforementioned embodiments.

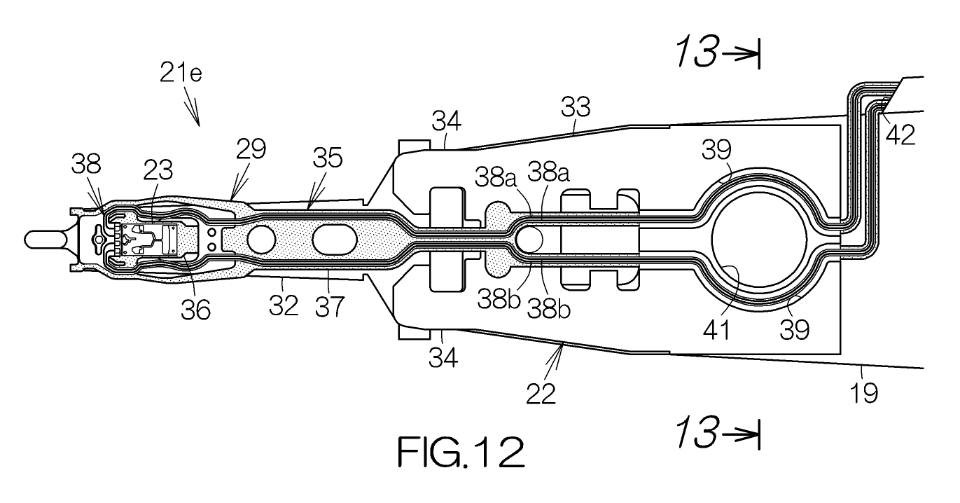

FIG. 12 schematically illustrates a head suspension assembly 21e according to a sixth embodiment of the preset invention. The hinge plate 33 extends on the base plate 31 in the head suspension assembly 21e. Spot welding is employed to fix the hinge plate 33 to the front surface of the base plate 31, for example. The grooves 39 are formed in the hinge plate 33 within an area received on the base plate 31. The wiring pattern set 38 is located in the grooves 39. Etching may be effected on the hinge plate 33 to form the grooves 39, for example. The fixation plate 37 is omitted in the flexure 29 on the hinge plate 33.

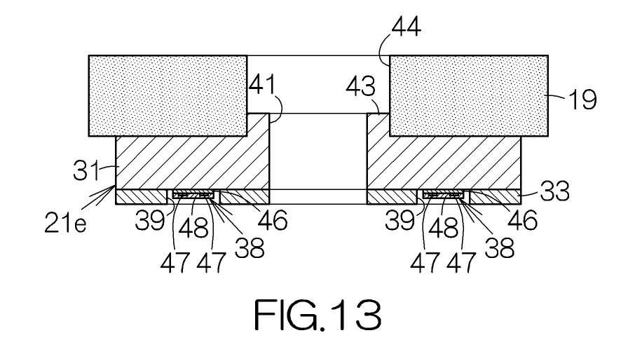

As shown in FIG. 13, the wiring pattern set 38 is contained in the hollow spaces defined between the grooves 39 and an imaginary plane including the front surface of the hinge plate 33 within an area received on the base plate 31. The wiring pattern set 38 is attached to the bottom surfaces of the grooves 39 within the grooves 39. An adhesive is utilized to attach the wiring pattern set 38, for example. Like reference numerals are attached to the structure or components equivalent to those of the aforementioned head suspension assemblies 21, 21a, 21b, 21c, 21d. The head suspension assembly 21e is allowed to enjoy the advantages identical to those obtained in the aforementioned embodiments. It should be noted that the fixation plate 37 may be extend on the hinge plate 33 within the grooves 39. In this manner, the wiring pattern 38 may be received on the fixation plate 37 within the grooves 39.

The head suspension assemblies 21-21e may include a viscoelastic body may be filled in the grooves 39. The viscoelastic body serves to prevent vibration of the wiring pattern set 38 and the flexure 29 with a higher reliability. The flying head slider 23 can be positioned with a higher accuracy.

What is claimed is:

1. A head suspension unit comprising:
a base plate;
a load beam coupled to a front end of the base plate;
a groove formed on a surface of the base plate; and
a flexure extending from the load beam and received in the groove of the base plate, the flexure extending outward from a contour of the base plate.

2. The head suspension unit according to claim 1, wherein the flexure is contained in a space defined between the groove and an imaginary plane including the surface of the base plate.

3. The head suspension unit according to claim 1, wherein the groove reaches the contour of the base plate at a rear end of the base plate.

4. The head suspension unit according to claim 3, wherein the groove extends symmetrically relative to a longitudinal centerline of the base plate.

5. The head suspension unit according to claim 1, wherein the base plate has a first surface and a second surface at a backside of the first surface, the base plate receiving the load beam on the first surface, the groove being formed on the second surface.

6. The head suspension unit according to claim 1, further comprising a hinge plate coupling the base plate to the load beam.

7. A head suspension assembly comprising:
a base plate;
a load beam coupled to a front end of the base plate;
a groove formed on a surface of the base plate;
a flexure extending from the load beam and received in the groove of the base plate, the flexure extending outward from a contour of the base plate; and
a head slider mounted on a surface of the flexure on the load beam.

8. The head suspension assembly according to claim 7, wherein the flexure is contained in a space defined between the groove and an imaginary plane including the surface of the base plate.

9. The head suspension assembly according to claim 7, wherein the groove reaches the contour of the base plate at a rear end of the base plate.

10. The head suspension assembly according to claim 9, wherein the groove extends symmetrically relative to a longitudinal centerline of the base plate.

11. The head suspension assembly according to claim 7, wherein the base plate has a first surface and a second surface at a backside of the first surface, the base plate receiving the load beam on the first surface, the groove being formed on the second surface.

12. The head suspension assembly according to claim 7, further comprising a hinge plate coupling the base plate to the load beam.

13. A carriage comprising:
a carriage block supported on a support shaft for relative rotation;
a carriage arm defined in the carriage block, the carriage arm extending forward;
a base plate attached to a front end of the carriage arm;
a load beam coupled to a front end of the base plate, the load beam extending forward from the front end of the base plate;
a groove formed in a surface of the base plate;
a flexure extending from the load beam and received in the groove of the base plate, the flexure extending outward from a contour of the base plate; and
a head slider mounted on a surface of the flexure on the load beam.

14. A storage apparatus comprising:
a carriage block supported on a support shaft for relative rotation;
a carriage arm defined in the carriage block, the carriage arm extending forward;
a base plate attached to a front end of the carriage arm;
a load beam coupled to a front end of the base plate, the load beam extending forward from the front end of the base plate;
a groove formed in a surface of the base plate;
a flexure extending from the load beam and received in the groove of the base plate, the flexure extending outward from a contour of the base plate; and
a head slider mounted on a surface of the flexure on the load beam.

15. A head suspension unit comprising:
a base plate;
a load beam coupled to a front end of the base plate;
a flexure body extending on the load beam and the base plate, the flexure body extending outward from a contour of the base plate;
a groove formed on a surface of the flexure body on the base plate; and
a wiring pattern formed on the surface of the flexure body, the wiring pattern received in the groove on the base plate.

16. A head suspension unit comprising:
a base plate;
a load beam distanced forward from a front end of the base plate at a predetermined interval;
a hinge plate attached to the base plate and the load beam;
a groove formed on a surface of the hinge plate on the base plate; and
a flexure extending on the load beam and the base plate and received in the groove of the hinge plate, the flexure extending outward from a contour of the base plate.
